(19) United States
(12) Patent Application Publication
(10) Pub. No.: US 2009/0320301 A1
(43) Pub. Date: Dec. 31, 2009

(54) Hand-held circular saw

(75) Inventors: Viktor Heinrichs, Untermeitingen (DE); Johannes Stempfhuber, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/459,110

(22) Filed: Jun. 26, 2009

(30) Foreign Application Priority Data
Jun. 30, 2008 (DE) 10 2008 040 017.3

(51) Int. Cl. B27B 9/00

(52) U.S. Cl. 30/374; 30/390; 30/520

(57) ABSTRACT

A hand-held circular saw (10) includes a housing (11); a drive (13) located in the housing for driving a circular saw blade (12), a cover element (15) for at least partially covering a working space (14) for the circular saw blade (12) and which defines a working plane (W), first and second main handles (21, 22) located opposite each other, and first and second switches (23, 24) provided on the first and second main handles (21, 22) respectively, for turning the drive (13) on and off.

### BACKGROUND OF THE INVENTION

1. Field of the Invention

The present invention relates to a hand-held circular saw including a housing, a drive located in the housing for driving a circular saw blade, a cover element for at least partially covering a working space for the circular saw blade and which defines a working plane, first and second main handles located opposite each other, and first and second switches provided on the first and second main handles respectively, for turning the drive on and off.

2. Description of the Prior Art

Circular saws of the type described above have a disc-shaped circular saw blade that rotates during an operation and serves, e.g., for producing cuts in workpieces.

German Publication DE 103 45 765 A1 discloses a circular saw having a motor for driving a saw blade and located in a saw housing, and a cover element for at least partially covering the saw blade. At the base of the circular saw, there is provided a guide shoe for placing the circular saw on a workpiece and for guiding the circular saw along the workpiece. For operating the saw by a user, the circular saw is provided with a main handle on which a switch for actuating the saw is arranged. The main handle extends on a side of the cover element in a plane extending parallel to the plane defined by the saw blade.

The circular saw, which is disclosed in DE 103 45 765 A1, is optimally adapted to be operated by a left-handed person because the motor is located, with reference to the main handle of the circular saw, on the left side. However, the saw is hardly suitable for being operated by a right-handed person.

Accordingly, an object of the present invention is to provide a hand-held circular saw well suited for being operated by both a left-handed person and a right-handed person.

### SUMMARY OF THE INVENTION

This and other objects of the present invention, which will become apparent hereinafter are achieved by providing a second main handle located opposite the first main handle and equipped with a further switch for turning the drive on and off.

The second main handle with a further switch insures that a circular saw can be used by both a left-handed person and a right-handed person. There is no need to manufacture expensive different tools for left-handed and right-handed persons.

Advantageously, a convenient geometry is obtained when both the first and second main handles extend from two handle roots, respectively. The handle roots of both main handles lie on an axis that extends parallel to the working plane.

It is further advantageous when both main handles define a common handle plane extending parallel to the working plane. This eliminates recoil of the circular saw in both sawing directions to a most possible extent. Further, the danger of the circular saw run-out in both sawing directions is eliminated.

It is convenient when both main handles are provided on opposite sides of the working space. This insures a particularly good control of the circular saw by the user.

It is advantageous when both main handles are formed as one-piece with the cover hood of the cover element. This insures a cost-effective manufacturing due to a reduced number of parts.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side view of a hand-held circular saw according to the present invention; and

FIG. 2 a plan view of the circular saw shown in FIG. 1 in direction of arrow II in FIG. 1.

### DETAILED DESCRIPTION OF THE PREFERRED EMBODIMENT

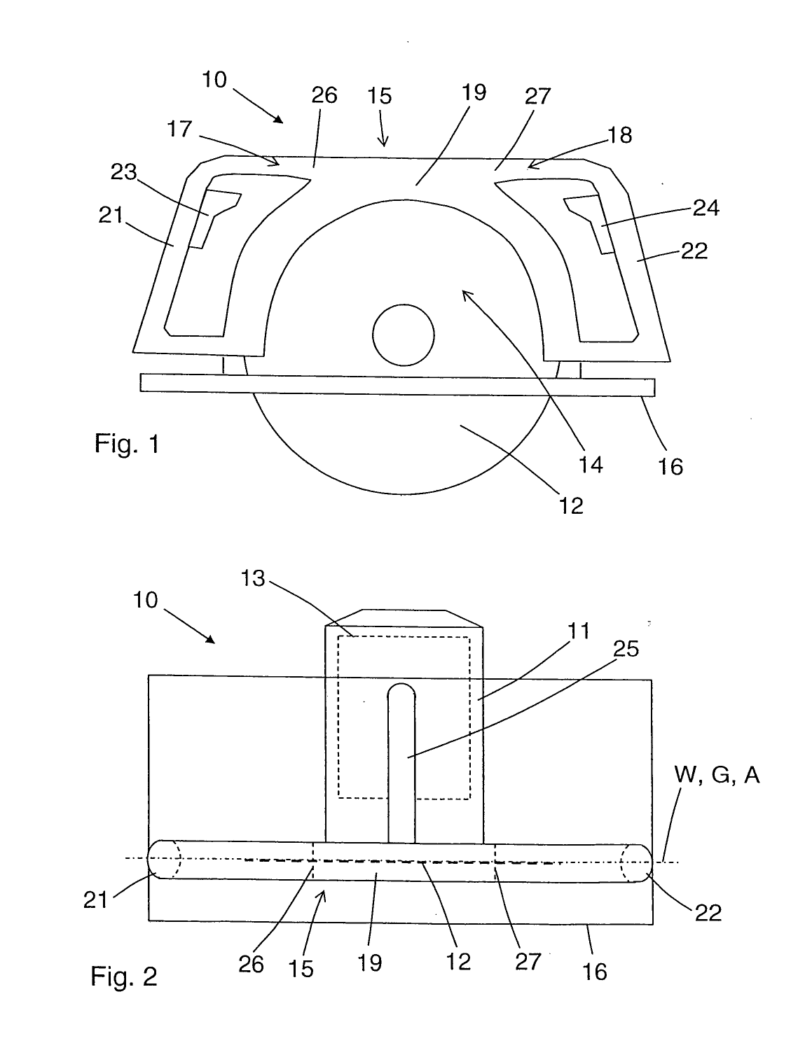

A hand-held circular saw 10 according to the present invention, which is shown in FIGS. 1 and 2, has a disc-shaped circular saw blade 12 for separating workpieces and which is driven by a drive 13 located in a housing 11. The circular saw 10 further has a cover element 15 with a cover hood 19 that partially surrounds a working space 14 and that partially shields the circular saw 12 outwardly. The working space 14 defines a working plane W. A guide shoe 16, which is provided on the circular saw 10, serves for placing the circular saw 10 on a workpiece and for guiding the circular saw 10 along the workpiece.

On the circular saw 10, there is further provided a main handle 21 on which a switch 23 for turning the drive 13 on and off is arranged. The main handle 21 is provided on a first side 17 of the cover hood 19. A second main handle 22 is provided on a second side 18 of the cover hood 19 and which is located opposite the first side 17. On the second main handle 22, there is provided another switch 24 for turning the drive 13 on and off. For turning the drive 13 on, simply one of the switches 23 and 24 need be actuated. Two handle roots 26, 27 of the main handles 21, 22 which branch from the cover hood 19 lie on an axis A that extends parallel to the working plane W. Parallel to the working plane W also means that the axis A extends in the working plane W itself. On the circular saw 10, there is further provided an auxiliary handle 25 that extends transverse to the working plane W. The auxiliary handle 25 usually is not provided with a switch but can have one.

The two main handles 21, 22 define a common handle plane G that extends parallel to the working plane W. Here, parallel to the working plane W also means that the two planes G and W coincide with each other.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held circular saw (10), comprising a housing (11); a drive (13) located in the housing for driving a circular saw blade (12); a cover element (15) for at least partially covering a working space (14) for the circular saw blade (12) and which defines a working plane (W); first and second main handles (21, 22) located opposite each other; and first and second switches (23, 24) provided on the first and second main handles (21, 22) respectively, for turning the drive (13) on and off.

2. A circular saw according to claim 1, wherein the first and second main handles (21, 22) extend from two handle roots (26, 27), respectively, the two handle roots (26, 27) lying on an axis (A) extending parallel to the working plane (W).

3. A circular saw according to claim 1, wherein the first and second main handles (21, 22) define a common handle plane (G) extending parallel to the working plane (W).

4. A circular saw according to claim 1, wherein the first and second main handles (21, 22) are provided on opposite sides (17, 18) of the working space (14).

5. A circular saw according to claim 1, wherein the cover element (15) has a cover hood (19), and the first and second handles (21, 22) form a single piece with the cover hood (19).
